(19) United States
(12) Patent Application Publication
(10) Pub. No.: US 2004/0252623 A1
(43) Pub. Date: Dec. 16, 2004

(54) Optical record carrier and optical scanning device

(76) Inventor: Hans Willem Van Kesteren, Eindhoven (NL)

Correspondence Address: Philips Electronics North America Corporation, Corporate Patent Counsel, PO Box 3001, Briarcliff Manor, NY, 10510, US

(21) Appl. No.: 10/492,666

(22) PCT Filed: Oct. 16, 2002
(86) PCT No.: PCT/IB02/04279

(30) Foreign Application Priority Data
Oct. 19, 2001 (EP) 01203949.1

(51) Int. Cl. G11B 3/00; G11B 5/09

(52) U.S. Cl. 369/275.4; 369/59.14

(57) ABSTRACT

An optical record carrier includes an information layer having substantially parallel tracks (11-16). The information is recorded in a pattern of optically detectable marks. The tracks are arranged in groups, each group including at least one first track (11, 13, 15) having broad marks (18) and at least one second track (10, 12, 14, 16) having narrow marks (17) of a second width smaller than the first width. The radiation spot (19) for which the secretary is designed to be scanned the width, is larger than the track period.

The invention relates to an optical record carrier including an information layer having substantially parallel tracks for recording information in a pattern of optically detectable marks. The invention also relates to an optical player for scanning such an optical record carrier.

In conventional optical recording, based on scalar diffraction effects, the information density of an optical record carrier reaches its bounds when the width of the marks approach is λ/3, where X is the wavelength of the radiation beam used for scanning. However, when use is made of so-called vector diffraction effects, marks having a width smaller than λ/3 can still be read out.

The U.S. Pat. No. 5,880,838 discloses several methods for determining structural parameters, such as a length and depth, of such small marks by measuring the intensity of radiation reflected by the marks and the phase difference between polarisation components of the reflected beam. The disadvantage of these methods is, that they do not reduce cross-talk from neighbouring tracks. Without cross-talk reduction the relatively large scanning spot precludes reduction of the track pitch, and the density increase caused by the vector diffraction effects will only be obtained in the track direction.

It is an object of the invention to provide an optical record carrier in which the density increase is obtained both in the track direction in the direction transverse to the track direction, while allowing inter-track cross-talk reduction when scanning. Another object is to provide a scanning device for scanning such a record carrier.

The first object is achieved, if, according to the invention, the tracks on this record carrier are arranged in groups, each group including at least one first track having broad marks having a first width and at least one second track having narrow marks of a second width smaller than the first width. The invention is based on the insight, that one can discriminate between radiation reflected from narrow marks and radiation reflected from broad marks by using the fact that the width of a mark affects the state of polarisation of a radiation beam when reflecting from that mark. Hence, when a radiation spot simultaneously covers a track comprising broad marks and a neighbouring track comprising narrow marks, the reflected radiation can be discriminated by the state of polarisation of the radiation. In a scanning device the cross-talk reduction can be achieved by two detection systems having different sensitivities to the state of polarisation of the radiation coming from the record carrier.

Preferably, the first width is larger than λ/(1.5 n) and the second width is smaller than λ/(1.5 n). In this case, scanning of the broad marks will not give substantial vector-diffraction effects and scanning of the narrow marks will give substantial vector-diffraction effects. A vector diffraction effect useful for reading narrow marks is the change in the state of polarisation of a radiation beam on a reflection from such a mark. The broad marks can be read in the conventional way, for instance by measuring the intensity changes of the radiation beam reflected from the broad marks. To reduce cross-talk from the narrow marks on the reading of broad marks, the detection of the radiation beam reflected from the broad marks can be made insensitive to changes in the state of polarisation of the radiation beam. To reduce cross-talk from the broad marks when reading the narrow marks, the detection of the radiation reflected from the narrow marks should be insensitive to changes in the intensity of radiation beam.

In an alternative embodiment of the record carrier, the first width is larger than λ/(2 n) and the second width is smaller than λ(2 n). The broad marks will then give a small vector diffraction effect and the narrow marks will give a substantial vector diffraction effect. The difference between the two effects can be used to discriminate between radiation coming from broad marks and that coming from narrow marks.

A better reduction of the cross talk can be achieved, if the second width is smaller than λ/(3 n).

A special embodiment of the record carrier, suitable for scanning a first and second track simultaneously with one radiation spot, includes groups comprising one first track and one second track. The arrangement of tracks will then be: first, second, first, second, etc. Another special embodiment includes groups comprising a second track, a first track and another second track, giving the following arrangement of tracks: second, first, second, second, first, second, second, first, second, etc. This embodiment as suitable for being scanned by three spots, one for each track of a group.

The second object of the invention is met, if an optical scanning device for scanning an information layer having said first tracks and said second tracks, the device including a radiation source for generating a radiation beam having a state of polarisation and an objective system for converging the radiation beam on the information layer, wherein, according to the invention, the device includes a first detection system sensitive to a first characteristic of radiation incident on it for converting radiation from the information layer to a first electrical signal representing information stored in the broad marks, and a second detection system sensitive to a second characteristic different from the first characteristic of radiation incident on it for converting radiation from the information layer to a second electrical signal representing information stored in the narrow marks. An example of the first characteristic is the intensity of the radiation beam, making the first detection system suitable for detecting radiation from broad marks in the conventional manner. An example of the second characteristic is the state of polarisation of the radiation beam, making the second detection system suitable for detecting radiation from narrow marks. The two different detection systems allow reading information in a conventional manner, as used for broad marks, and in a meadow using vector-diffraction effects, as used for narrow marks.

It should be noted, that one embodiment of a scanning device disclosed in said U.S. Pat. No. 5,880,838 comprises two detection systems. The two output signals of the detection systems represent two characteristics of the radiation reflected by narrow pits, which characteristics are used to derive structural parameters of the pits, such as length and depth. The two signals do not represent information stored in two different tracks of the record carrier which comprise marks having different widths; instead, the represent information stored in a marks of a single track.

In a special embodiment of the scanning device, the radiation beam forms a single spot on the information layer extending over one of the first tracks and one of the neighbouring second tracks. The broad and narrow marks in two adjacent tracks are read simultaneously. The radiation beam coming from the information layer is optically split into two beams, one of which is directed to the first detection system and the other to the second detection system.

In this embodiment, radiation of the spot is preferably linearly polarised in a direction under 45 degrees with the track direction. The 45 degrees is suitable for determining changes in the state of polarisation when reading narrow marks. The same state of polarisation can be used for reading broad marks. To reduce cross talk, the first detection system preferably filters out optically a linear polarisation under zero degrees or 90 degrees with the track direction out of the radiation beam coming from the information layer.

In another embodiment, the radiation beam forms a first spot and a second spot on the information layer, the first spot extending over one of the first tracks and the second spot extending over one of the second tracks. This allows the radiation in each of the spots to be given a state of polarisation adapted to the width of the marks. For optimum detection radiation of the first spot is preferably linearly polarised perpendicular to the track direction and radiation of the second spot is preferably linearly polarised under 45 degrees with the track direction.

The invention will now be described in greater detail by way of example with reference to the accompanying drawings in which:

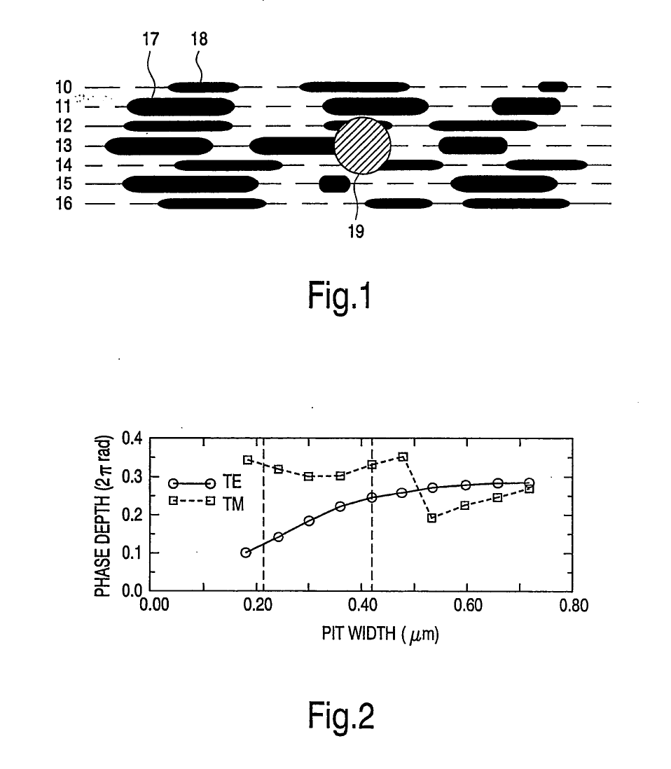

FIG. 1 shows a record carrier according to the invention;

FIG. 2 shows phase depth of a pit as a function of the width of the pit having a depth of a quarter of a wavelength; and

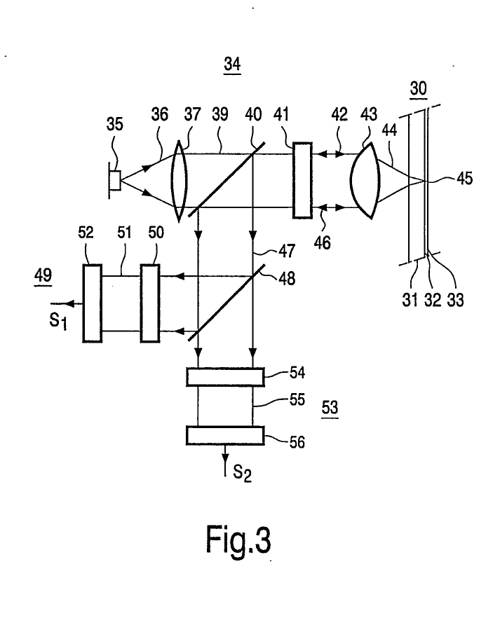

FIG. 3 shows a scanning device according to the invention.

FIG. 1 shows part of an information layer of an optical record carrier according to the invention. It shows seven tracks (10-16), indicated by the dashed centre line of each track. The tracks comprise broad marks (17) and narrow marks (18) in the form of pits having a first width and a second width larger than the first width, respectively. Within one track the width is constant and the widths in adjacent tracks differ. The varying length of the marks and of the spaces between the marks represent the information recorded, similar to the way in which information is recorded on conventional CD-ROM discs. A scanning spot 19 follows track 13. Its width is larger than the track pitch, causing the spot to cover both first and second tracks.

The tracks are arranged in groups of two neighbouring tracks, i.e. a first track 11, 13, 15 and a second track 10, 12, 14, 16. The track pitch is 370 nm. The width of the broad marks on the first tracks is equal to 250 nm, the width of the narrow marks on the second tracks is equal to 120 nm. The depth of the pits is equal to a quarter wavelength. The record carrier is designed for being read out by a radiation beam having a wavelength of 650 nm and a numerical aperture of 0.60. On its radiation-incident side the information layer is covered with a transparent layer of polycarbonate having a refractive index of 1.58 and a thickness of 0.6 mm.

When the mark width is a fraction of the wavelength, the phase depth of the mark will be different for a polarisation direction of the radiation perpendicular to the track direction (denoted by TE) and for a polarisation direction along the track direction (denoted by TM). Calculated phase depths are known from said U.S. Pat. No 5,880,838 and are shown in FIG. 2. For an appropriate choice of the difference in mark widths of neighbouring tracks as well as the polarisation state of the scanning beam, the reflected light can be given distinct polarisation characteristics, for instance a rotated linear polarisation state for one track and a circular polarisation state for the adjacent track. These two polarisation states can be considered as independent read-out channels.

The separation of the radiation into two channels in the scanning device facilitates the generation of a radial tracking error signal. Since each of the channel sees only half of the tracks, i.e. it observes tracks having an apparent period of 740 nm, the first diffraction order of the beam reflected by the information layer will at least partly pass through the objective system. The interaction of the zero diffraction order and first diffraction order of the reflected beam in the optical system can be used for generating the radial tracking error signal, for instance by using the well-known push-pull method.

FIG. 3 shows an optical record carrier 30. The record carrier includes a transparent layer 31 through which the scanning radiation beam accesses an information layer 32. The information layer is protected against environmental influences by a layer 33. The record carrier is scanned by an optical scanning device 34. The device includes a radiation source 35, for instance the semiconductor laser, for forming a diverging radiation beam 36. A collimator lens 37 transforms the radiation beam 36 to a collimated beam 39. After passage through a beam splitter 40, the beam is incident on an optical converter 41. The converter adapts the radiation beam 39 to radiation beam 42 suitable for scanning the information layer 32. The converter may change the single beam 39 to a main beam and two sub beams by means of a diffraction grating. It may also change the state of polarisation of radiation beam 39 e.g. by means of a quarter-lambda wave plate. The converter may be arranged between the radiation source 35 and the beam splitter 40. An objective system 43 focuses the collimated beam 42 to a converging beam 44, which forms a spot 45 on the information layer 32. Although the objective system is shown as a single lens, it may comprise two or more lenses and/or diffractive elements.

Radiation reflected from the information layer 32 returns along the part of the forward beam. After passage through the objective system 43 it forms a collimated beam 46, and, after passage through the converter 41 and reflection by the beam splitter 40, a collimated beam 47. The beam splitter 48, which may be polarisation sensitive, directs part of the radiation beam 47 to a first detection system 49. The detection system is sensitive to a first characteristic of radiation incident on it and includes a first optical filter 50 to make the detection system sensitive to radiation from the broad marks on the record carrier. The optical filter may include a polariser, a quarter lambda plate or a polarisation-sensitive beam splitter. The beam coming from the optical filter may include two or more sub beams, and is incident on a detector 52. The detector may comprise several detector elements, which may be arranged to intercept the sub beams of radiation beam 51 where appropriate. The electrical output signal(s) S₁ of the first detection system 49 represents information read from the broad marks in the first tracks and may also represent focus and radial tracking error signals from the first tracks.

Part of the collimated radiation beam 47 is transmitted by the beam splitter 48 and is incident on a second detection system 53. The detection system is sensitive to a second characteristic of radiation incident on it and includes a second optical filter 54 to make the detection system sensitive to radiation from the narrow marks on the record carrier. The second optical filter 54 forms a radiation beam 55 incident on a detector 56. The electrical output signal(s) S2 of the second detection system 53 represents information read from the narrow marks in the second tracks and may also represent focus and radial tracking error signals from the second tracks.

In an embodiment of the scanning device where radiation reflected from the broad marks is linearly polarised under 45 degrees with the plane of the drawing and radiation reflected from the narrow marks is circularly polarised, the beam splitters 40 and 48 are of the non-polarising type. During reading both TE- and TM-polarised radiation fields should be present, for instance by choosing the direction of the linear polarisation of the incident radiation beam at an angle of 45 degrees with respect to the track direction. In that case the TE and TM fields have an equal magnitude and phase.

The first optical filter 50 includes a polarising beam splitter of which the normal on the beam splitting face forms an angle of 45 degrees with the plane of the drawing. The two sub beams formed by the polarising beam splitter are incident on two detector elements and the electrical output signals of the detector elements are subtracted. The output signal S₁ is related to the intensity of the linearly polarised radiation beam. The circularly polarised light incident on the first detection system 49, will result in equal signals of the two detector elements, and does therefore not affect the output signals S₁.

The second optical filter 54 in said embodiment includes a quarter-lambda plate and after it a polarising beam splitter, of which the normal on the beam splitting face forms an angle of 45 degrees with the plane of the drawing. The two sub-beams formed by the polarising beam splitter are incident on two detector elements and the electrical output signals of the detector elements are subtracted. The output signal S₂ is related to the intensity of the circularly polarised radiation beam. The linearly polarised radiation incident on the second detection system 53 causes equal signals of the two detector elements, and does therefore not affect the output signals S₂.

As shown in FIG. 2, the difference in phase depths for marks of for instance 0.4 μm and 0.15 μm is already quite close to the requirements given above. The optimum choice of the width depends on the depth of the pits and the reflecting layer covering the pits, for instance a thin metal layer. The phase and amplitude of the TE and TM modes can be optimised by arranging a dielectric layer on the radiation incident side of the reflecting layer. Other choices can be made for the state of polarisation of the incident radiation and for the specific state of polarisation detected in the two detection systems.

In a conventional ROM disc the track width is generally comparable to the spot size. For such a disc, the reduction of the track width to half the spots size is not feasible because the first diffraction order of the reflected beam falls outside of the detection aperture. According to the invention, the track density can in principle become twice as high, because of the a priori knowledge of the polarisation state of the reflected radiation from adjacent tracks.

The radial tracking error can be generated in a nearly conventional way by using split detectors and detecting the symmetry of the first order diffracted radiation. The main difference is that these patterns are detected in the first detection system for one mark width and in the second detection system for the other mark width. The scanning device need not comprise four (split) detectors. The conventional MO detector configuration with two (split) detectors can be used when a mechanism is incorporated to introduce or remove mechanically the quarter wave plate of the scanning device.

The signals from marks with narrow widths, much smaller than the spots size, will have a sufficient SNR due to the fact that the differential detection method is applied instead of a direct intensity management as in the conventional ROM system. For instance, laser intensity noise will no longer limit the SNR, because it is cancelled in the differential detector. Furthermore, the effects on the polarisation in the proposed ROM record carrier are larger than the small Kerr rotations of MO media.

1. An optical record carrier including an information layer having substantially parallel tracks for recording information in a pattern of optically detectable marks, characterised in that the tracks are arranged in groups, each group including at least one first track having broad marks of a first width and at least one second track having narrow marks of a second width smaller than the first width.

2. The optical record carrier according to claim 1 adapted to being scanned by a radiation beam of wavelength λ, wherein the first width is larger than λ/(1.5 n) and the second width is smaller than λ/(1.5 n), in which n is the refractive index of a material adjoining the information layer on its radiation-incident side.

3. The optical record carrier according to claim 2, wherein the second width is smaller than λ/(3 n).

4. The optical record carrier according to claim 1, wherein each group includes a first track having a second track on each side.

5. An optical scanning device for scanning an information layer having first tracks and second tracks according to claim 1, the device including a radiation source for generating a radiation beam having a state of polarisation and an objective system for converging the radiation beam on the information layer, characterised in that the device includes a first detection system sensitive to a first characteristic of radiation incident on it for converting radiation from the information layer to a first electrical signal representing information stored in the broad marks, and a second detection system sensitive to a second characteristic different from the first characteristic of radiation incident on it for converting radiation from the information layer to a second electrical signal representing information stored in the narrow marks.

6. The optical scanning device according to claim 5, wherein the radiation beam forms a single spot on the information layer extending over one of the first tracks and one of the neighbouring second tracks.

7. The optical scanning device according to claim 6, wherein radiation of the spot is linearly polarised in a direction under 45 degrees with the track direction.

8. The optical scanning device according to claim 5, wherein the radiation beam forms a first spot and a second spot on the information layer, the first spot extending over one of the first tracks and the second spot extending over one of the second tracks.

9. The optical scanning device according to claim 8, wherein radiation of the first spot is linearly polarised perpendicular to the track direction and radiation of the second spot is linearly polarised under 45 degrees with the track direction.
